(19) United States
(12) Patent Application Publication
(10) Pub. No.: US 2021/0154680 A1
(43) Pub. Date: May 27, 2021

(54) ELECTRODE ELEMENTS OF HIGH RESISTIVITY FOR TWO-STEP ELECTROFILTER

(71) Applicants: Eurus AirTech AB, Åkersberga (SE); LightAir Holding AB, Solna (SE)

(72) Inventors: Andrzej Loreth, Åkersberga (SE); Peter Holmberg, Ramsjö (SE)

(73) Assignees: Eurus AirTech AB, Åkersberga (SE); LightAir Holding AB, Solna (SE)

(21) Appl. No.: 17/047,624

(22) PCT Filed: Mar. 11, 2019
(86) PCT No.: PCT/SE2019/050214

§ 371 Date: Oct. 14, 2020

(30) Foreign Application Priority Data
Apr. 18, 2018 (SE) 1850448-0

(51) Int. Cl. B03C 3/47; B03C 3/12; B03C 3/08; B03C 3/41; B03C 3/60

(52) U.S. Cl. CPC B03C 3/47; B03C 3/12; B03C 3/60; B03C 3/41; B03C 3/08

(57) ABSTRACT

A device comprising a group of electrode elements for two-step electrofilters in a condenser separator, which group of electrode elements comprises at least two strip shaped electrode elements (A, B), or two groups of planar disc-shaped electrode elements (A, B), the electrode elements (A, B) to a major part being comprised of a core (M1), and wherein at least one of the electrode elements (A, B) or group of electrode elements (A, B) is formed of at least two different polymers with different electrical properties, wherein a portion (M1, M3, M3′) of the electrode element (A) that is disposed closest to an adjacent second electrode element (B) in the condenser separator is formed of a polymer having a surface resistivity of more than 1×10¹² ohm/kV, and wherein a second portion of the electrode elements (A, B) is comprised of at least one current conductive element (M2, M2′, M2″) in the form of a polymer in the form of a thin coating on the core (M1) of the electrode elements (A), or is embedded in said core (M1) with an extension that is substantially smaller than the extension of the core (M1), both with respect to the width and the depth.

The invention relates to a device comprising a group of electrode elements for two-step electrofilters in a condenser separator, which group of electrode elements comprises at least two strip shaped electrode elements or two groups of planar disc-shaped electrode elements.

### STATE OF THE ART

Until now, the dominant technique for purifying airborne particulate pollutants is and has been so-called mechanical filters, of the Hepa type or the like.

These are constructed around thin fibres of various materials and are characterized in that the thinner the fibres used are, the better separation may be achieved, especially with respect to small particles. With increasing air purification efficiency, mechanical filters also exhibit undesirable increasing pressure drops through the filter with increasing purification capability.

The development of two-step electrofilters has led to efficient air purifiers equipped with so-called condenser separators of high resistivity comprising high resistive electrode elements mainly made of specially designed paper. These air cleaners can be designed as electrode elements in the form of thin sheets (discs) arranged with gap spacing with respect to each other or as a cylindrical body formed of two strip-like electrode elements.

In the Swedish patent application 9602211-6, a two-step electrofilter with an ionization section is described which, downstream in the air flow direction, is followed by a so-called condenser separator.

The condenser separator consists of two strip-shaped electrode elements which are multiply wound around a bobbin with a gap distance “d” between the respective electrode elements. Such a condenser separator has a substantially cylindrical body. The air flow through the condenser separator is directed in the axial direction and through slots “d” that are open to an air flow between adjacent electrode elements.

The condenser separator according to the above can advantageously be designed with a specially elaborated paper in accordance with the Swedish patent No. SE 0103684-7. In practice, there is no limit to the size of the filter units that can be made with respect to the diameter of the condenser separator and thus large amounts of air can be handled by a device provided with only one condenser separator. However, the influence of moisture on the electrode elements of the condenser separator constitutes a practical limiting factor, which also affects the efficiency.

### OBJECTS AND FEATURES OF THE INVENTION

It is an object of the present invention to provide a suitable design of the electrode elements of a condenser separator of the kind presented above (electrode elements of high resistivity or groups thereof) with better operating liability with respect to moisture influence, but also with increased mechanical properties than corresponding electrode elements comprised of cardboard.

This is achieved in accordance with the invention by means of a group of electrode elements for two-step electrofilters in a condenser separator, which group of electrode elements comprises at least two strip-shaped electrode elements or two groups of planar disk-shaped electrode elements, the electrode elements to a major part being comprised of a core, and wherein at least one of the electrode elements or group of electrode elements is formed of at least two different polymers with different electrical properties, wherein the portion of an electrode element that is arranged closest to an adjacent second electrode element of the condenser separator is formed of a polymer having a surface resistivity of more than 1×10¹² ohm/sq and preferably more than 1×10¹⁴ ohm/sq, wherein a second part of the electrode elements is comprised of at least one current conductive element in the form of a polymer in a thin coating on the core of the electrode elements, or is embedded in said core with an extension that is substantially smaller than the extension of the core along both the width and the depth.

In a specific embodiment, the volume resistivity of the polymer in the portion of the electrode element that is arranged closest to the adjacent second electrode element in the condenser separator should be at least 1×10¹¹ ohm-cm and preferably not less than 1×10¹³ ohm-cm.

In a specific embodiment, the surface resistivity of the current conductive elements should be less than 1×10⁸ ohm/sq and preferably less than 1×10⁵ ohm/sq, and the volume resistivity should be less than 1×10⁷ ohm-cm and preferably less than 1×10⁴ ohm-cm.

In a specific embodiment, the portion of an electrode element that is arranged closest to the adjacent second electrode element in the condenser separator is comprised of an insulation layer.

In a specific embodiment, the insulation layer also encloses the edge sections of the respective electrode elements.

In a specific embodiment, groups of the electrode elements are formed as planar sheets, wherein multiple current conductive elements are arranged offset relative to each other and perpendicular to the intended air flow direction through the condenser separator.

In a specific embodiment, several separate connections to a high voltage source are provided by edge connection of the respective current conductive elements by means of a conductive material.

In a specific embodiment, the core of the electrode elements is thinner than 0.7 mm and preferably thinner than 0.4 mm.

In a specific embodiment, the current conductive elements on the electrode elements or on the groups of electrode elements are offset with respect to each other in such a way that two adjacent electrode elements do not have current conductive elements located at the same corresponding position.

### DETAILED DESCRIPTION

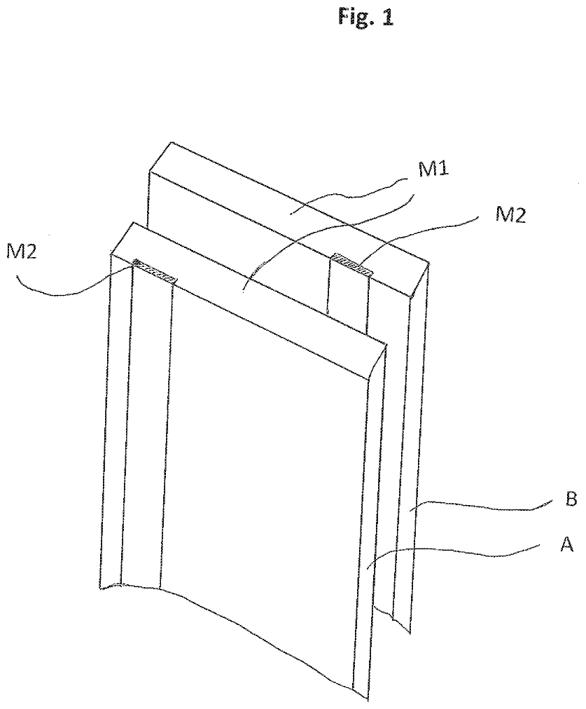

As shown in FIG. 1, the electrode elements A, B in the form of thin strips consisting of two polymers are assembled with each other during the manufacturing process.

A major layer consists of a thin core M1 of a polymer of high ohmic resistance and with a surface resistivity that is greater than 1×10¹⁰ ohm/sq or a volume resistivity that is greater than 1×10⁹, and preferably with a surface resistivity that is greater than 1×10¹² ohm/sq or a volume resistivity that is greater than 1×10¹¹.

At least one current conductive element M2 of a conductive polymer extends to one edge section of the core M1, with an extension that is substantially smaller than the extension of the core M1 with respect to both the width and the thickness. In the shown embodiment, the current conductive elements M2 run along the whole length of the electrode element A, B, on one side of said electrode element.

The surface resistivity of the current conductive elements M2 is preferably less than 1×10⁸ ohm/sq or their volume resistivity should be less than 1×10⁷ ohm-cm and preferably less than 1×10⁵ ohm/sq and 1×10⁴ ohm-cm, respectively.

If two electrode elements in a condenser separator are designed in accordance with the present invention, these should advantageously be mirror images of one another, i.e. the current conductive elements M2 in the respective electrode elements A, B should be arranged at opposite edge sections. I.e. if a current conductive element M2 on a first side of a first electrode element A is located at a first distance from the first edge of the electrode element A and thus clearly farther away from the second edge of the electrode element A, then a current conductive element M2 on an adjacent second electrode element B should advantageously be located at said first distance from the second edge of the electrode element B and hence clearly farther away from the first edge of the electrode element B.

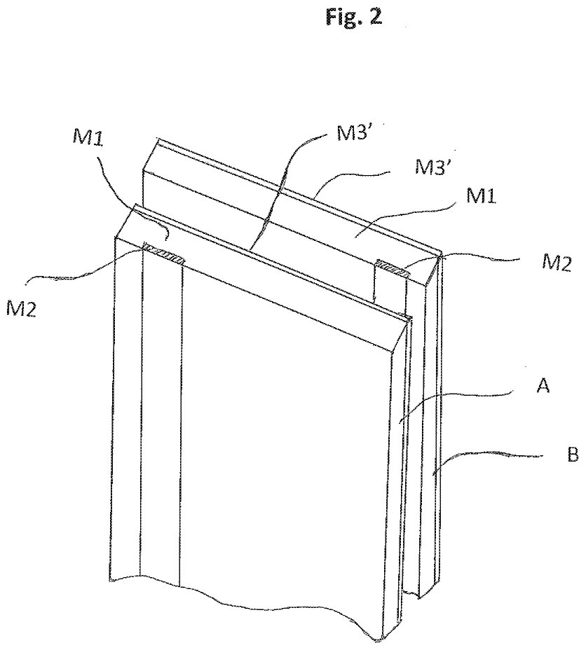

FIG. 2 shows a modified embodiment of the invention wherein the respective electrode elements A, B, at least on one side thereof, are coated with a thin film of insulating polymer M3′, i.e. a polymer with higher surface resistivity than 1×10¹² ohm/sq and at least 10 times as high surface resistivity (or volume resistivity) as the resistivity of the core M1.

Preferably, the back side of the electrode elements A, B are coated with said thin film of insulating polymer M3′, the back side being the side electrode elements A, B which are not coated with current conductive elements M2.

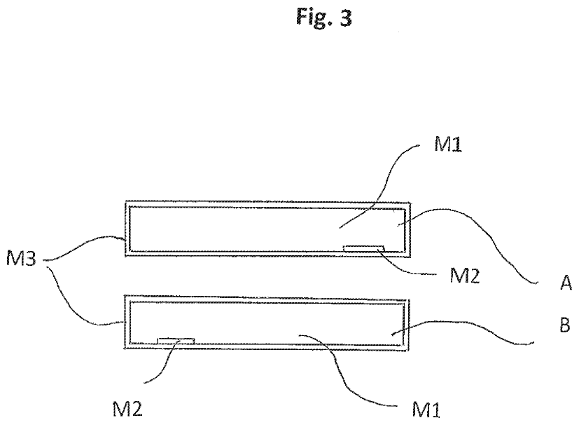

FIG. 3 shows yet another modified embodiment of the embodiment shown in FIG. 2.

In this embodiment, an insulating polymer M3 is arranged to enclose the entire electrode elements A or B, one of them or both, including its edge sections and including the current conductive elements M2.

### Possible Modifications

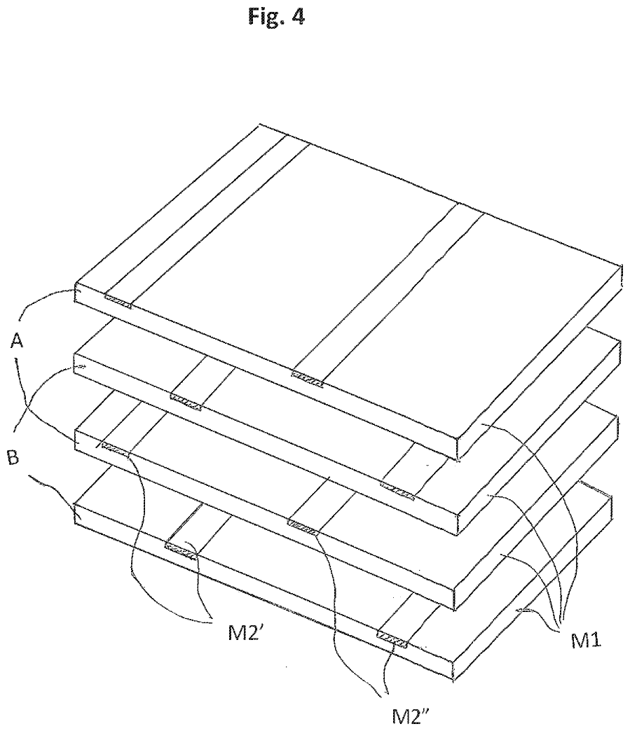

Of course, it is not necessary that the electrode elements A, B have the shape of long strip-like elements. As illustrated in FIG. 4, the elements A, B may be in the form of rectangular/square sheets consisting of the core M1 and preferably several current conductive elements M2′, M2″ arranged at a distance from each other and embedded in the core or arranged as a thin coating on the core M1. FIG. 4 schematically shows disk-shaped electrode elements A, B with several current conductive elements M2′ and M2″.

In the embodiment shown in FIG. 4 the current conductive elements M2, M2′, M2″ are all arranged at the same corresponding side. However, the present invention is not limited to current conductive elements M2, M2′, M2″ provided only on one side of core M1. Current conductive elements M2, M2′, M2″ may very well be provided on both sides of the core M1.

With several current conductive elements (coatings) M2, M2′, M2″, several individual high voltage connections can be arranged, which is of particular importance when the electrode elements in question are flat electrode elements arranged with a gap with respect to each other in a condenser separator with a square or rectangular inlet area. In such an embodiment, the current conductive elements M2, M2′, M2″ should preferably be arranged perpendicular to the air flow direction L through the condenser separator, as shown in FIG. 4.

With a mutual displacement of the current conductive elements on the closest electrode elements A, B, the respective groups of the electrode elements A, B can be connected to different poles of the high-voltage source, preferably with an edge connection formed of a conductive material such as conductive rubber, conductive foam plastic, conductive hot-melt adhesive or the like.

For example, the current conductive coating M2, M2′, M2″ may be Polypropylene specified as PP 1379 with a volume resistivity of less than 1×10³ ohm-cm and a surface resistivity of less than 1×10⁴ ohm/sq.

The core M1 can, for example, be formed of polypropylene with a volume resistivity that is preferably greater than 1×10¹⁰ ohm-cm.

1. A device comprising a group of electrode elements for a two-step electrofilter in a condenser separator, which group of electrode elements comprises at least two strip shaped electrode elements, or two groups of planar disc-shaped electrode elements, wherein the electrode elements to a major part are comprised of a core, and wherein at least one of the electrode elements or group of electrode elements is formed of at least two different polymers with different electrical properties, wherein a portion of an electrode element that is arranged closest to an adjacent second electrode element in the condenser separator is formed of a polymer having a surface resistivity of more than 1×10¹² ohm/sq and preferably more than 1×10¹⁴ ohm/sq, wherein a second portion of the electrode elements is comprised of at least one current conductive element in the form of a polymer arranged as a thin coating on the core of the electrode elements, or is embedded in said core with an extension that is substantially smaller than the extension of the core along both the width and the depth.

2. The device according to claim 1, wherein the volume resistivity of the polymer in the portion of an electrode element that is arranged closest to the adjacent second electrode element in the condenser separator must be at least 1×10¹¹ ohm-cm.

3. The device according to claim 1, wherein the surface resistivity of the current conductive elements should be less than 1×10⁸ ohm/sq, and the volume resistivity should be less than 1×10⁷ ohm-cm.

4. The device according to claim 1, wherein the portion of an electrode element which is arranged closest to the adjacent second electrode element in the condenser separator is comprised of an insulation layer.

5. The device according to claim 4, wherein the insulation layer also encloses the edge sections of the respective electrode elements.

6. The device according to claim 1, wherein groups of the electrode elements are formed as flat sheets, wherein several current conductive elements are arranged off-set with respect to each other and perpendicular to the intended air flow direction through the condenser separator.

7. The device according to claim 6, wherein several separate connections to a high voltage source are provided by an edge connection of the respective current conductive elements by means of a conductive material.

8. The device according to claim 1, wherein the core of the electrode elements is thinner than 0.7 mm.

9. The device according to claim 1, wherein the current conductive elements on the electrode elements or on groups of the electrode elements are off-set with respect to each other in such a way that two adjacent electrode elements do not have current conductive elements located at the same corresponding position.
